(19) United States
(12) Patent Application Publication
(10) Pub. No.: US 2006/0187500 A1
(43) Pub. Date: Aug. 24, 2006

(54) Image reading device, image forming apparatus, and image reading method

(76) Inventor: Yasuo Sakurai, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/346,300

(22) Filed: Feb. 3, 2006

(30) Foreign Application Priority Data
Feb. 18, 2005 (JP) 2005-042309

(51) Int. Cl. H04N 1/04

(52) U.S. Cl. 358/474; 358/509

(57) ABSTRACT

An image reading device that reads image information by irradiating an illuminating light onto a document by an illumination unit and converting a reflected light from a surface of the document to an electric signal by a photoelectric transducer, wherein the illumination unit includes a plurality of light emitting diodes (LED) and an infrared-cut unit that cuts a light having a wavelength in an infrared region from the illuminating light emitted by the LEDs.

### CROSS-REFERENCE TO RELATED APPLICATIONS

The present document incorporates by reference the entire contents of Japanese priority document, 2005-042309 filed in Japan on Feb. 18, 2005.

### BACKGROUND OF THE INVENTION

1. Field of the Invention

The present invention relates to an image reading device that irradiates an illuminating light onto a document, converts a reflected light from a document surface to an electric signal by a photoelectric transducer, and reads out image information on the document, an image forming apparatus having a copying function such as a monochrome image forming apparatus, a full-color image forming apparatus, or a multifunction product (MFP) provided with this image reading device, and an image reading method applied to the same.

2. Description of the Related Art

FIG. 15 is a view showing a schematic configuration of an image reading device (hereinafter, referred to as a “scanner”) that reads a document image, which has conventionally been carried out. A scanner 200 is basically composed of a document mount (contact glass) 11 on which a document is placed, first carriage 3 installed at a lower-surface side of this document mount 11 and mounted with a light source 1 and a first mirror 2, a second carriage 6 provided with second and third mirrors 4 and 5, an imaging lens 7 into which a reflected light from a document guided via first to third mirrors 2, 4, and 5 is made incident, and a charge-coupled device (CCD) (imaging element) 8 that reads and photoelectrically converts a document image imaged on an imaging plane by the imaging lens 7, and reads a document image by shifting the second carriage 6 at a scanning speed ½ times that of the first carriage 3 in a sub-scanning direction.

The first carriage 3 is, as shown in FIG. 16, provided with a cylindrical xenon lamp 9 stored in a cover 13 on which an opening 12 is formed at a contact glass 11 side as a light source 1, and onto the contact glass 11 side, a direct light from the xenon lamp 9 and a reflected light from an opposite reflecting plate 10 provided at an exit of the cover 13 are irradiated. Then, a reflected light in a high-illuminance region is guided from the first mirror 2 to the second and third mirrors 4 and 5. In the light source constructed as such, since the imaging positions are different among respective colors of R, G, and B, an illuminance distribution sufficiently uniform to cover this difference of the imaging positions is required for a document surface.

Meanwhile, recently, light-emitting diode (LED) light sources (point light sources) have been examined in consideration of energy savings, a rate of rise, reliability, and the like, and as an LED used for a light source of this type, an invention disclosed in, for example, Japanese Published Unexamined Patent Application No. H11-317108 or Japanese Published Unexamined Patent Application No. 2001-285577 has been known. Of these, in Patent Document 1, an invention has been disclosed, wherein a resin prepared by dissolving red and green fluorescent materials into a transparent resin is arranged in front of blue LEDs so that a white light is irradiated.

In Patent Document 2, an invention has been disclosed, wherein by arranging a yttrium aluminum garnet (YAG)-based fluorescent screen in a scanning mechanism (first carriage) of an image reading device, a light irradiated from a blue LED in the first carriage is whitened and is used as a light source.

Reading of a document image is carried out by a CCD as described above. Characteristics of CCDs that have been currently used in image reading devices show, as shown in CCD sensitivity characteristics of FIG. 17, high sensitivities at a long wavelength (red end), which is different from human vision characteristics. Namely, CCDs have sensitivities in an infrared region, which is unnecessary for human vision characteristics. In addition, according to FIG. 17, even G (green) and B (blue) have sensitivities in a range of 750 nanometers to 1000 nanometers, and lights in this range are merely visible as in colors of only a red end to human eyes, however, in CCDs, there are outputs in G and B (outputs from CCDs: no black is outputted). Therefore, R, G, and B lose balance, which results in poor color reproducibility.

Meanwhile, in some drawing materials, for example, black ballpoint pens, as can be understood from reflection characteristics ((1) to (6) of six companies' products), black color has color characteristics at 650 nanometers or more. Black ballpoint pen ink having such reflection characteristics can be seen as black color to human eyes, however, red colors are detected by CCDs as shown in FIG. 17. Therefore, as a result of binarization in a black and red mode, copies of black ballpoint pen images may become black and red images in some cases. In a case of full-color, images where red is blurred in black are produced.

On the other hand, when xenon lamps are used as illuminating light sources as in the prior art as described above, as shown in a spectral characteristics diagram (two companies A and B, shown as (1) and (2) in the diagram) of FIG. 19, the xenon lamps emit light before and after 850 nanometers, and the wavelengths are in infrared regions excellent in sensitivity for CCDs. Therefore, although correction of images depending on CCD sensitivities and light source spectral characteristics in these infrared regions are carried out by an image processing or the like, owing to a fluctuation in CCD sensitivities, document color characteristics, and the like, it is difficult to coincide with color reproduction perceived by human eyes. Therefore, by cutting wavelengths before and after 850 nanometers of the xenon lamps by use of, for example, an infrared-cut filter or an infrared-cut lens, this problem is solved. However, xenon lamps do not emit light entirely from 400 nanometers to 700 nanometers, and there are missing parts as can be understood from an ink spectral characteristics diagram of FIG. 19. In particular, there are omissions before and after 510 nanometers to 540 nanometers and 570 nanometers. On the other hand, when GREEN of the color spectral reflectance characteristics is referred to, the green is a reflection component on the order of 500 nanometers. Omission of a part having this wavelength in a light source results in a condition without light, that is, black, thus it becomes impossible to reproduce vivid green.

Furthermore, halogen lamps can also be considered as light sources, and it can also be considered to use the same together with an infrared-cut filter and an infrared-cut lens in an infrared region, however, since halogen lamps are great in calorific values, and are also great in infrared components, if wavelengths in this region are cut, light efficiency is deteriorated, therefore, it is unsuitable to use halogen lamps as light sources to read color documents.

In order to solve these problems, it is sufficient to develop a CCD to match human vision characteristics, however, this is difficult with the present techniques.

### SUMMARY OF THE INVENTION

It is an object of the present invention to at least solve the problems in the conventional technology.

According to one aspect of the present invention, the image reading device that reads image information by irradiating an illuminating light onto a document by an illumination unit and converting a reflected light from a surface of the document to an electric signal by a photoelectric transducer is constructed such that the illumination unit includes LEDs and an infrared-cut unit that cuts a light having a wavelength in an infrared region from the illuminating light emitted by the LEDs.

According to another aspect of the present invention, the image reading device that reads image information by irradiating an illuminating light onto a document by an illumination unit and converting a reflected light from the document surface to an electric signal by a photoelectric transducer is constructed such that the illumination unit includes LEDs, a light guide member that guides an illuminating light emitted by the LEDs toward the document surface, and an infrared-cut unit that cuts a light having a wavelength in an infrared region from the illuminating light emitted by the light guide member.

According to still another aspect of the present invention, the image reading device that reads image information by irradiating an illuminating light onto a document by an illumination unit and converting a reflected light from the document surface to an electric signal by a photoelectric transducer is constructed such that the illumination unit includes LEDs that emit only a light having a wavelength shorter than a wavelength in an infrared region.

According to still another aspect of the present invention, the image reading device that reads image information by irradiating an illuminating light onto a document by an illumination unit and converting a reflected light from the document surface to an electric signal by a photoelectric transducer is constructed such that the illumination unit includes LEDs and an infrared-cut unit that cuts a light having a wavelength in an infrared region from the illuminating light emitted by the LEDs.

According to still another aspect of the present invention, the image forming apparatus includes an image reading device that reads image information by irradiating an illuminating light onto a document by an illumination unit and converting a reflected light from the document surface to an electric signal by a photoelectric transducer, wherein the illumination unit further includes LEDs, a light guide member that guides an illuminating light emitted by the LEDs toward the document surface, and an infrared-cut unit that cuts a light having a wavelength in an infrared region from the illuminating light emitted by the light guide member.

According to still another aspect of the present invention, the image forming apparatus includes an image reading device that reads image information by irradiating an illuminating light onto a document by an illumination unit and converting a reflected light from the document surface to an electric signal by a photoelectric transducer, wherein the illumination unit further includes LEDs that emit only a light having a wavelength shorter than a wavelength in an infrared region.

According to still another aspect of the present invention, an image reading method applied to read image information by irradiating an illuminating light onto a document and converting a reflected light from a document comprising: irradiating onto the document surface an illuminating light whose light component in an infrared region out of the visible light spectrum has been reduced to an intensity sufficiently low relative to a sensitivity of the photoelectric transducer, and reading the thus

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a view showing a configuration of a lighting system according to an embodiment of the present invention;

FIG. 2 is a view showing an example of light emission distribution of an LED with wide directivity;

FIG. 3 is a perspective view showing a relationship between LEDs and a light guide member;

FIG. 4 is a view showing a relationship between a directivity angle and a critical angle when light is totally reflected within a light guide member;

FIG. 5 is a view showing conditions of directivity angles when light is totally reflected within a light guide member and when light is transmitted therethrough;

FIG. 6 is a graph showing wavelength dependence of a silicon photo diode (SPD) sensitivity, a human visibility, and an infrared-cut filter transmittance.

FIG. 7A is a table and FIG. 7B is a graph showing properties and spectral transmittance of an infrared-cut filter, respectively;

FIG. 8 is a graph showing infrared removal characteristics of infrared-cut filters;

FIG. 9 is a view showing an example of a lighting system where an infrared-cut filter is provided on a plane of incidence of a light guide member;

FIG. 10 is a view showing an example of a lighting system where an infrared-cut filter is provided on a plane of emergence of an LED;

FIG. 11 is a view showing an example of a lighting system that uses, as a light guide member, an infrared-cut light guide member provided by molding an acrylic resin having infrared-cut characteristics;

FIG. 12 is a sectional view showing a configuration of a white LED according to a second embodiment of the present invention;

FIG. 13 is a graph showing spectral characteristics of a white LED;

FIG. 14 is a view showing a schematic configuration of an image forming apparatus according to an embodiment of the present invention;

FIG. 15 is a view showing a schematic configuration of an image reading device that scans a document image, which has conventionally been carried out;

FIG. 16 is a view showing a configuration of a lighting system using a xenon lamp as a light source;

FIG. 17 is a graph showing sensitivity characteristics of conventionally used CCDs;

FIG. 18 is a graph showing reflection characteristics of a black ballpoint pen ink;

FIG. 19 is a graph showing spectral characteristics of xenon lamps; and

FIG. 20 is a graph showing spectral characteristics of ink colors.

### DETAILED DESCRIPTION OF THE PREFERRED EMBODIMENTS

Embodiments of the present invention will be explained with reference to the drawings.

### First Embodiment

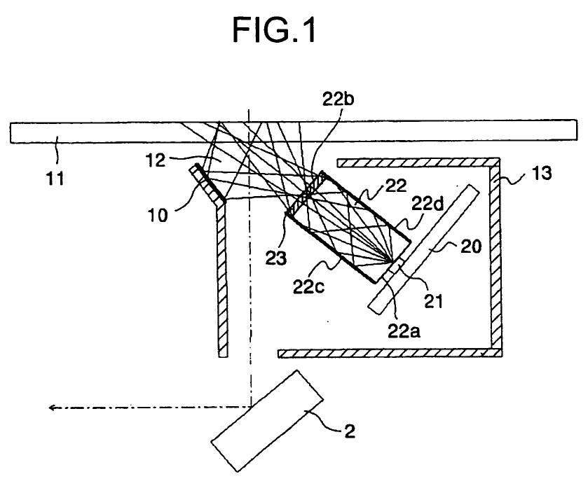

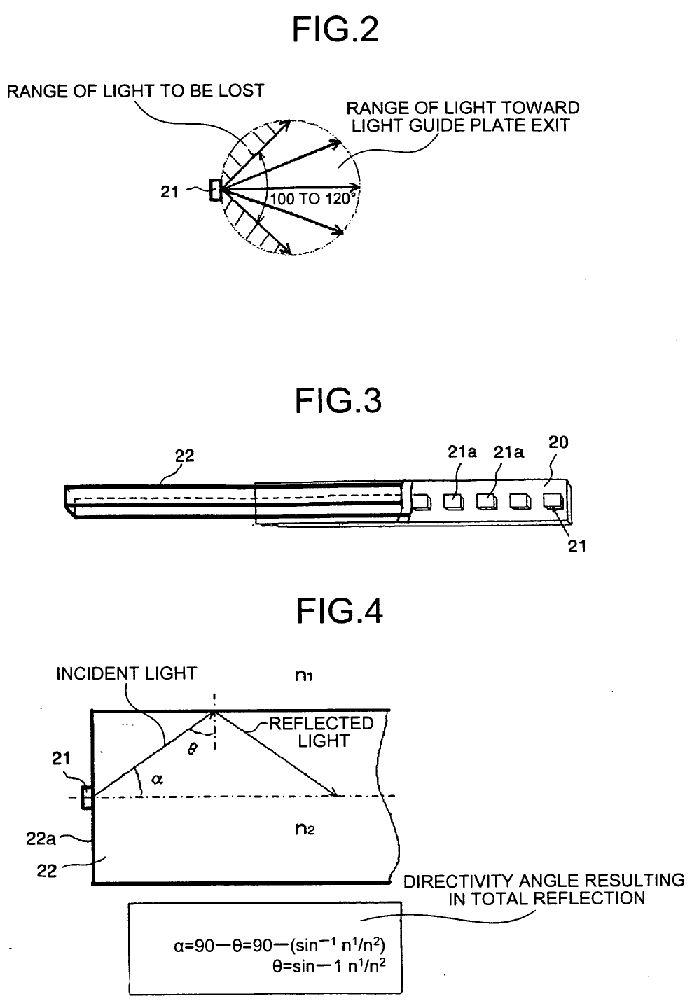

FIG. 1 is a view showing a configuration of a lighting system of an image reading device according to a first embodiment of the present invention. In the present embodiment, an LED with wide directivity 21 and a light guide member 22 are used as a light source. The LED 21 is mounted on a substrate 20, the light guide member 22 is arranged in a condition where one end face (plane of incidence, or simply “incident plane”) 22a makes contact with a light-emitting section of the LED 21 and the other end face (plane of emergence, or simply “emergent plane”) 22b side faces in an illuminating direction. FIG. 2 is a view showing an example of light emission distribution of the LED 21 with wide directivity. As shown in the same drawing, an illuminating light from the LED 21 is emitted in a range of 100° to 120° from a light-emitting plane. FIG. 1 is a sectional view showing a construction that guides an illuminating light from the LED 21 shown in FIG. 2 toward a to-be-irradiated plane by use of the light guide member 22, and in actuality, as shown in a perspective view of FIG. 3, the LEDs 21 are arrayed in a line form in a main-scanning direction at predetermined intervals, a narrow-width light guide member 22 is arranged in a rectangular shape in a section along light-emitting planes 21a of the LEDs 21, and a plane of emergence 22b of illuminating lights from the LEDs 21 is opposed to a to-be-irradiated plane (contact glass 11). On the plane of emergence 22b of the light guide member 22, an infrared-cut filter 23 that cuts an infrared region having a wavelength nearly 650 nanometers or more is provided, whereby that wavelength region of illuminating lights from the LEDs 21 that are emitted from the light guide member 22 is cut. In this embodiment, optical glass (crown glass) is used as a light guide member 22.

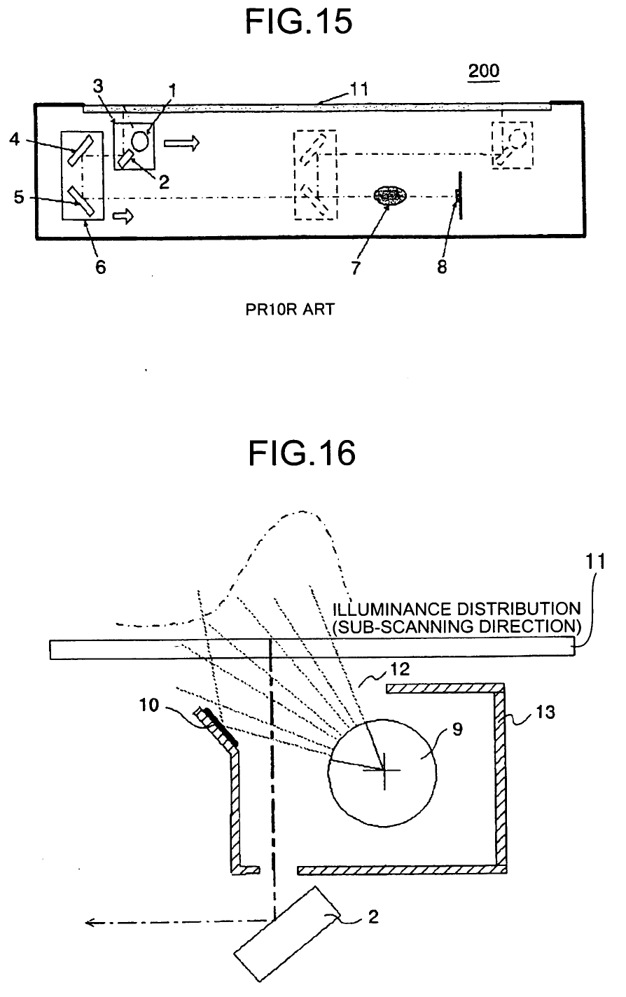

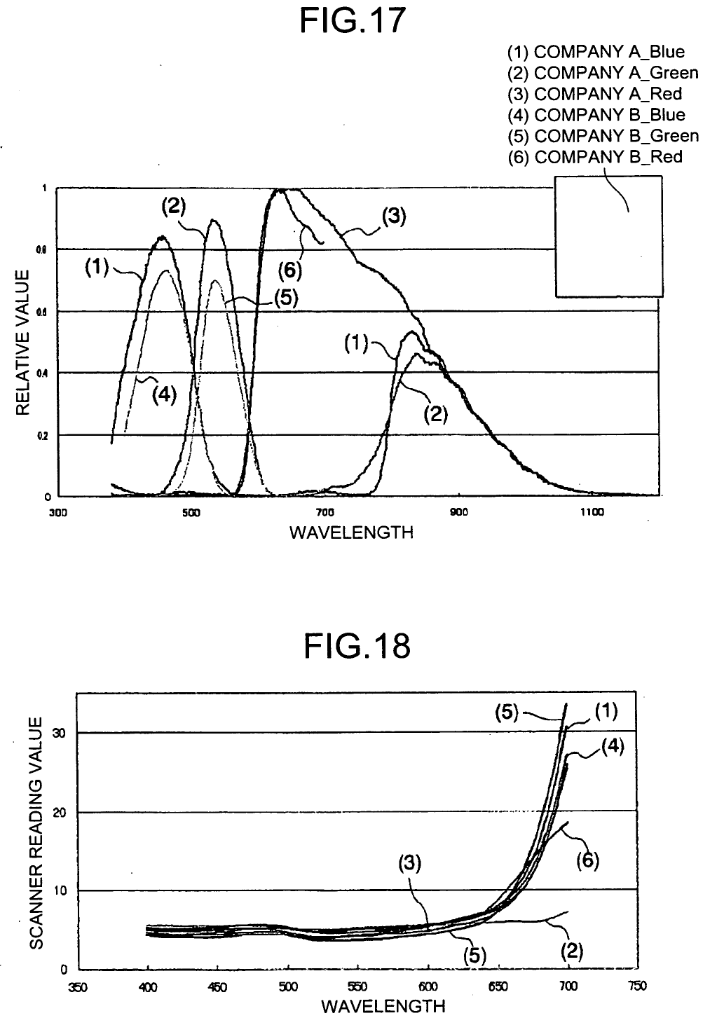

Since other respective units are constructed equivalent to those of FIG. 15 as described above, identical reference numerals will be used for identical components so as to omit repeated explanation.

In the light guide member 22, when a light is irradiated onto an air layer from the light guide member 22 as shown in FIG. 4, an angle not to be irradiated onto the air layer is determined based on a difference in refractive indexes between air and the light guide member 22. Namely, when a refractive index (n1) of an air layer that is the exterior of the light guide member 22 is provided as 1 and optical glass (crown glass) is used as a light guide member 22, since a refractive index (n2) of the optical glass which is the interior of the light guide member 22 is approximately 1.52, an angle not to be irradiated onto the air layer from the light guide member 22, that is, a critical angle θ (angle created by a normal line to a side surface of the light guide member 22 from an intersection between an optical path and the side surface of the light guide member 22 and the optical path) becomes
θ=sin−1(n1/n2),

therefore, when the light guide member 22 is made of optical glass, the critical angle θ becomes
θ=41°

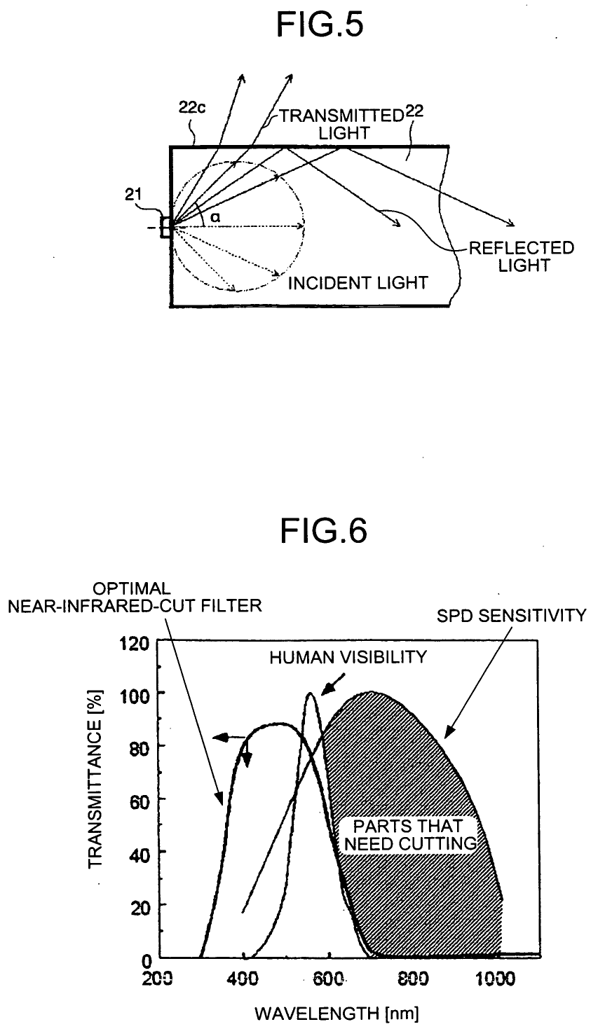

Namely, as shown in FIG. 5, at a directivity angle (α) of the LED 21 equal to or less than 49°, an emitted light from the LED 21 is reflected to the inside of the light guide member 22 without exiting a side surface of the light guide member 22. Thereby, as shown in FIG. 1, the light is totally reflected by the inner surface of the light guide member 22 and is guided upward over the LED 21 (direction of a directivity angle (α)=0°).

In the LED 21 with wide directivity as shown in FIG. 2, a light that is irradiated in a range of a directivity angle (α) of 49°×2, which is approximately 100°, is guided to the plane of emergence 22b of the light guide member 22 and a light irradiated in a remaining angle of 0° to 20° exits outside a side surface 22c of the light guide member 22. Accordingly, when optical glass (crown glass) is used for the light guide member 22, 80% or more of the irradiated light amount from the LEDs 21 is guided to the direction of the plane of emergence 22b of the light guide member 22.

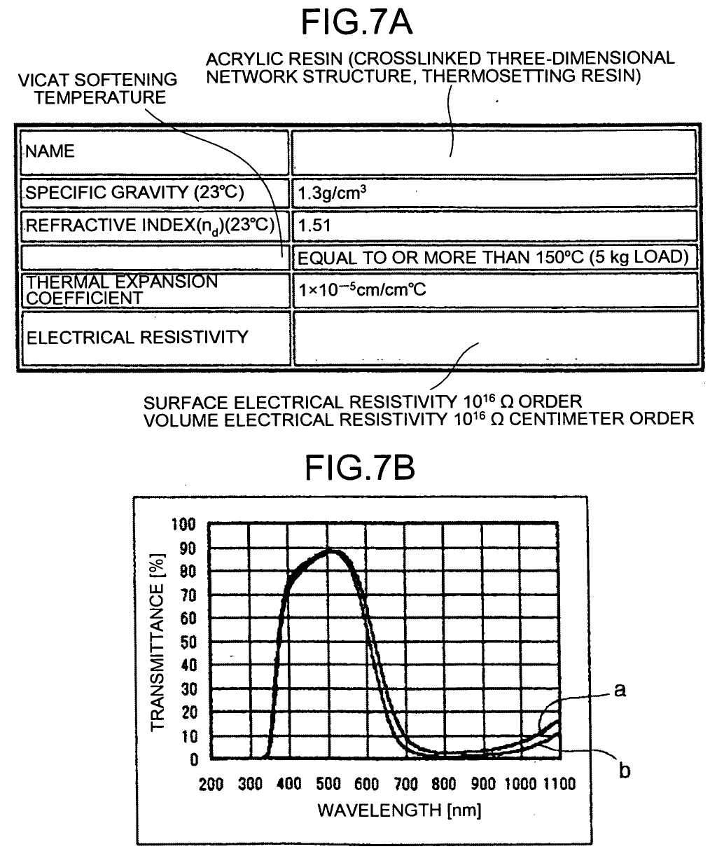

An infrared-cut filter 23 is, as can be understood from a graph showing wavelength dependence of an SPD (Silicon Photo Diode: silicon light-receiving element) sensitivity, a human visibility, and an infrared-cut filter transmittance, provided with characteristics to remove a wavelength region having an SPD sensitivity equal to or more than 650 to 700 nanometers so as to satisfy human vision characteristics based on a difference between a sensitivity of a silicon light-receiving element used for a CCD or CMOS image sensor and human vision characteristics (visibility). As the infrared-cut filter, for example, a filter called LUMICLE UCF/UCFD (trade name) produced by Kureha Chemical Industry Co., Ltd. is used. Properties and spectral transmittances thereof are shown in FIGS. 7A and 7B, respectively. In FIG. 7B, “a” shows characteristics of an infrared-cut filter having a thickness of 0.5 millimeter called UCF-02, while “b” shows characteristics of an infrared-cut filter having a thickness of 1.0 millimeter called UCF-22.

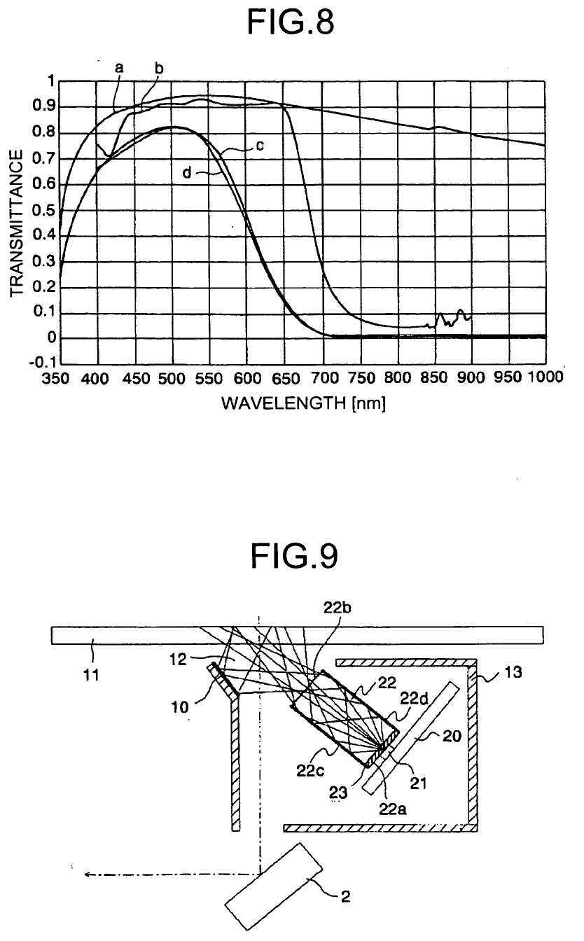

By using an infrared-cut filter 23 having such characteristics, an SPD sensitivity in an infrared region can be cut as shown in FIG. 6, whereby a CCD 8 can read a document image at characteristics close to human vision characteristics. FIG. 8 is a characteristics diagram showing spectral characteristics of a lens “a”, “b” prepared by applying an infrared-cut coating to the lens “a”, and combinations “c” and “d” prepared by a combination of a lens having characteristics of the lens “a” and an infrared-cut filter. It can be understood that, at the characteristics of “d” and “c”, a region having a wavelength equal to or more than 650 nanometers has been mostly removed and a region having a wavelength equal to or more than 700 nanometers has been completely removed, and at the characteristics of “b”, a region having a wavelength equal to or more than 750 nanometers has been mostly removed. For these characteristics, since a light having a wavelength in the region cannot be irradiated onto a document surface side owing to the infrared-cut filter 23 even when the CCD 8 has a long-wavelength sensitivity, the CCD 8 never reads a reflected light from a document surface in that region, thus a document is read at characteristics equivalent to those of reading by human eyes.

The infrared-cut filter 23 has a thickness of about 0.5 to 1.0 millimeter, and is used by adhering the same to the plane of emergence 22b of the light guide member 22, however, a coating that is the same in material as the infrared-cut filter may be applied to the plane of emergence 22b to form an infrared-cut filter layer.

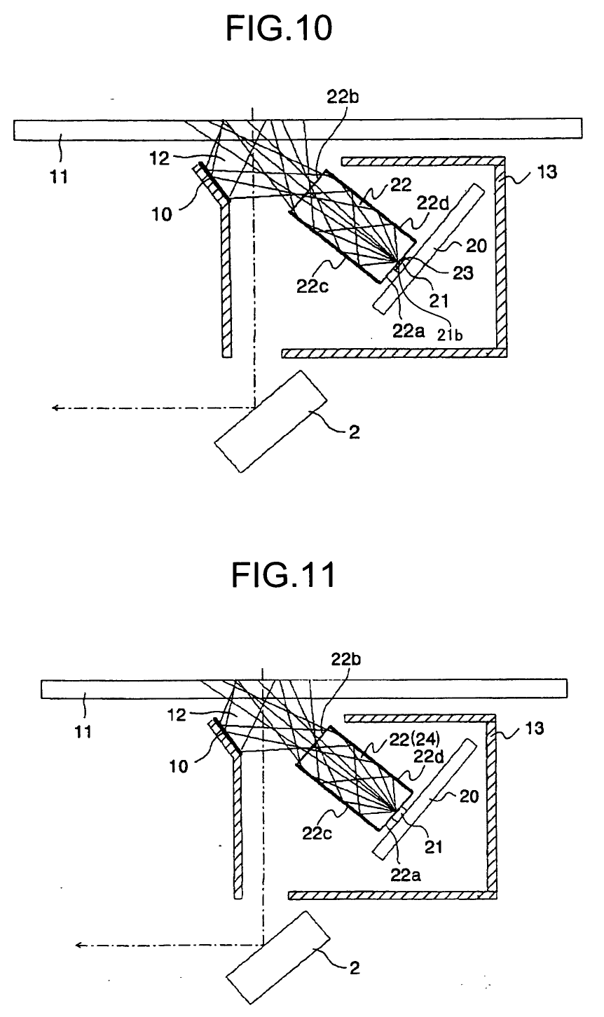

In FIG. 1, the infrared-cut filter 23 is provided on the plane of emergence 22b of the light guide member 22, however, the infrared-cut filter 23 may be provided on the plane of incidence 22a of the light guide member 22 as shown in FIG. 9. Alternatively, the infrared-cut filter 23 may be provided on the plane of emergence 21b of the LED 21 as shown in FIG. 10.

Furthermore, as shown in FIG. 7A, since the infrared cut filter 23 uses an acrylic resin similar to a plastic lens and has a refractive index of 1.51, as shown in FIG. 11, the light guide member 22 can be used as an infrared-cut light guide member 24 provided by molding the acrylic resin having infrared-cut characteristics. In this case, since a critical angle is also an angle equivalent to the angle θ, the infrared-cut light guide member 24 functions as a light guide member having characteristics equivalent to the optical glass.

The infrared-cut filter 23 can be composed of not only a resin having infrared-cut characteristics but also glass, and the light guide member 22 itself can also be formed of optical glass having infrared cut characteristics. Here, the term “optical glass” is optical glass having a uniform refractive index free from striae and transparency sufficient to be used as an optical instrument.

### Second Embodiment

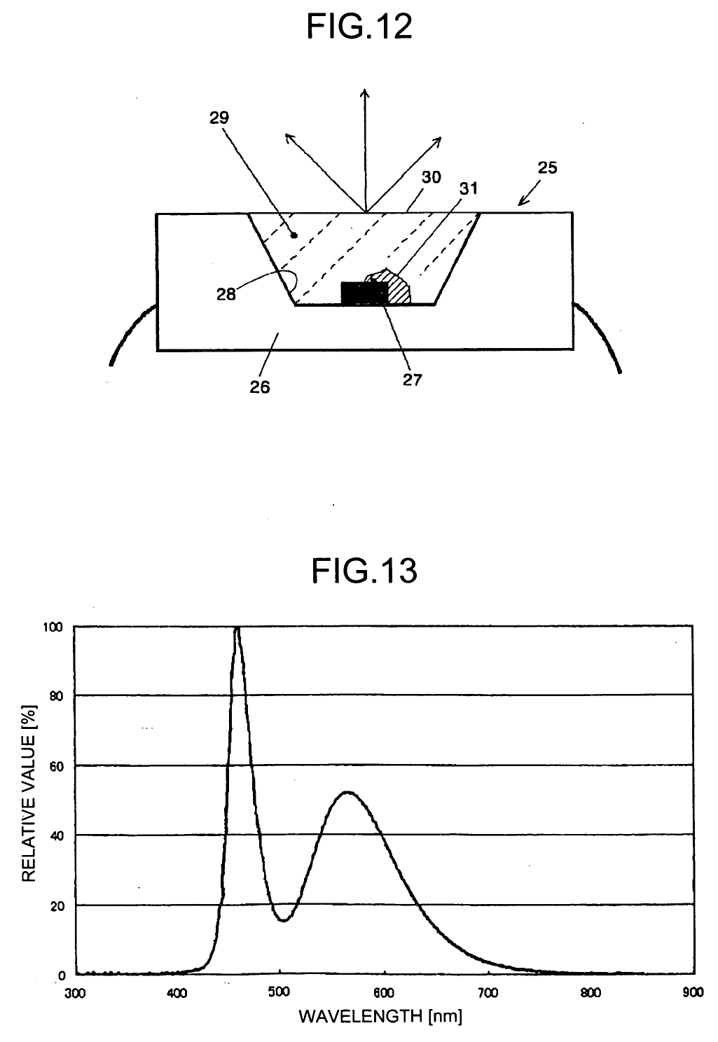

In the first embodiment, infrared rays are cut by a filter, a coating, a light guide member, or the like so as to illuminate a document by a light having a shorter wavelength than 650 nanometers to 700 nanometers of an infrared component as a reflected light from a document, whereas in this second embodiment, the region is cut from a light source itself. Accordingly, in the present embodiment, a white LED that does not emit light in the region is used. FIG. 12 is a sectional view showing a configuration of this white LED.

In FIG. 12, a white LED 25 is prepared by providing a concavity 28 at a front surface (surface at the light emitting side) of a light-emitting section 27 of a blue LED 26 and filling a yellow fluorescent material 29 in the concavity 28 so as to make a front surface (surface at an opening side) of the yellow fluorescent material 29 as a light-emitting plane 30. Here, numerical reference 31 denotes a lead. The blue LED 26 itself is a widely known GaN LED, and as the yellow fluorescent material 29, a YAG-based (yttrium aluminum garnet) fluorescent material is used.

In the white LED 25 constructed as such, the fluorescent material converts a blue light radiated from the light-emitting section 27 of the blue LED 26 to a yellow light. A part of the blue light radiated by the light-emitting section 27 of the blue LED 26 is transmitted through the yellow fluorescent material 29 layer, and the rest hits against the fluorescent material to become a yellow light. Then, the two transmitted blue and yellow lights show white as a result of mixing. As shown in the spectral characteristics diagram of FIG. 13, a light emitted from the white LED 25 constructed as such is an emission of light equal to or less than 5% of a peak value (in terms of a 460-nanometer peak value of an emission of light by a blue luminous body (GaN base): 100%) at equal to or more than 700 nanometers, and becomes 0.5% or less at 750 nanometers, therefore, no light is emitted in an infrared region. This means that, even when CCD 8 has a long-wavelength sensitivity, no reading in the infrared region is carried out since there is no emission of light at a wavelength longer than 700 nanometers from the light source.

Here, a white LED 25 may be constructed, without using a fluorescent material, by a combination of a blue emission of light by a ZnSe base (active layer) and a yellow light produced by absorbing the blue emission of light by a ZnSe single-crystal substrate. In a case of this example, as a result of reduction in an emission of light at a wavelength longer than 700 nanometers, since an LED having a greater output at a short-wavelength side is provided, this can be used as a light source of an image reading device.

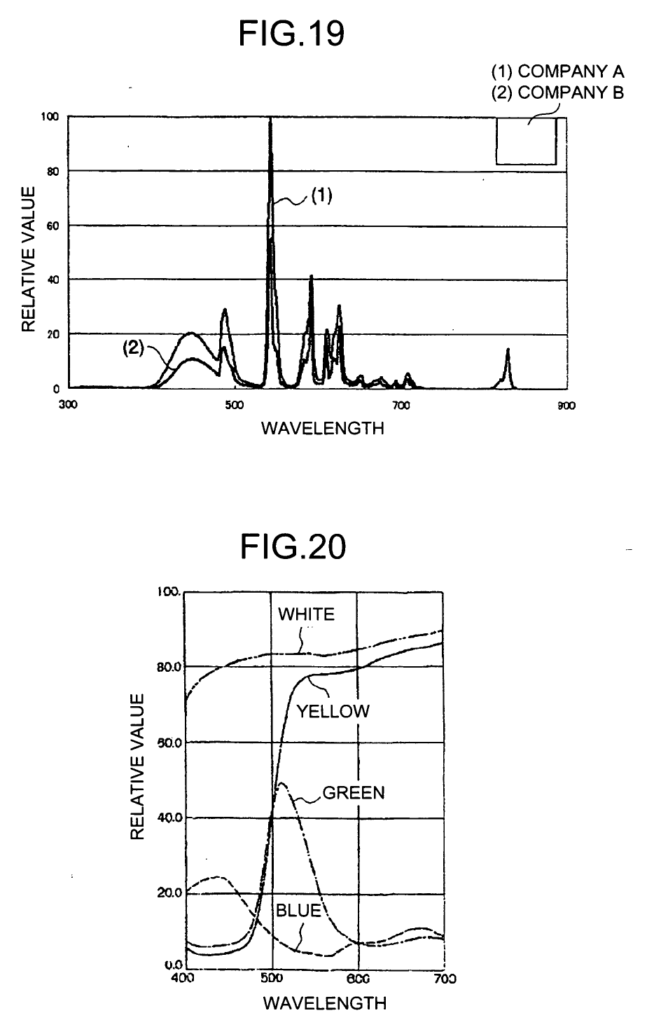

Furthermore, as shown in FIG. 20 described above, GREEN has continuous spectral characteristics in the vicinity of 480 nanometers to 560 nanometers. With characteristics of xenon lamps as shown in FIG. 19, since no light having a wavelength of 500 nanometers to 535 nanometers and 555 nanometers to 580 nanometers is irradiated, there is no reflected light and a reproduction of green is darkened, therefore, vivid green cannot be reproduced. However, when a white LED (irradiation by a blue luminous body and a yellow fluorescent material) 25 is used as a light source, as shown in FIG. 13, since light is continuously emitted in a visible light region without a break, there is no region where a reflected light is lost, and color never darkens.

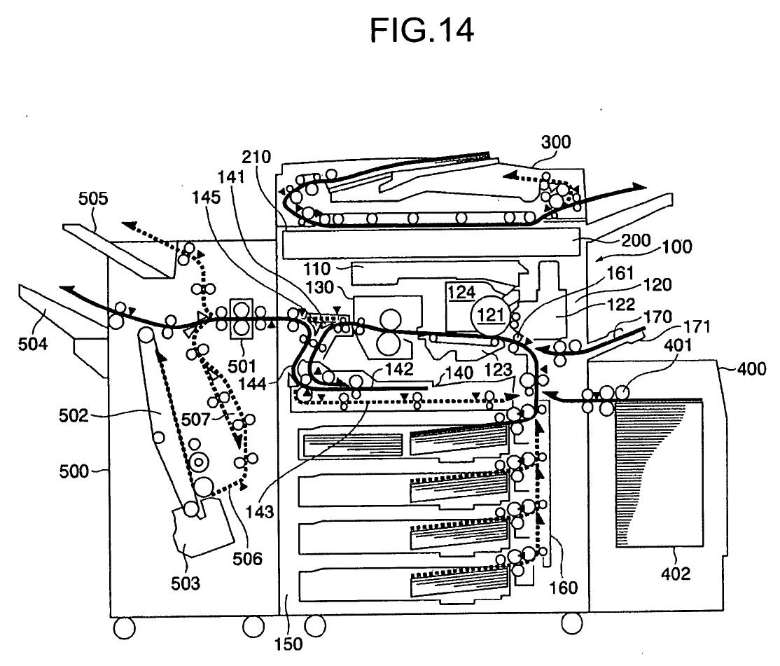

FIG. 14 is a schematic configuration view of the entire system showing an example of an image forming apparatus according to an embodiment of the present invention. In the same drawing, an image forming apparatus is basically composed of a body 100, an image reading device 200 installed on the top of the image forming apparatus body, an automatic document feeder (ADF) 300 attached further thereon, a large-capacity paper feeder 400 arranged at a right side of the image forming apparatus body 100 in FIG. 1, and a paper post-processing device 500 arranged on a left side of the image forming apparatus body 100 in FIG. 1.

The image forming apparatus body 100 is composed of an image writing unit 110, an image forming unit 120, a fixing unit 130, a double-sided conveying unit 140, a paper feeding unit 150, a vertical conveying unit 160, and a manual paper feeding unit 170.

The image writing unit 110 modulates a laser diode (LD) as a light emitting source based on image information of a document read out by the image reading device 200 and carries out a laser writing on a photoconductor drum 121 by an optical scanning system including a polygon mirror and a fθ lens. The image forming unit is composed of widely known electrophotographic image forming components such as a photoconductor drum 121, a developing unit 122 provided along the outer circumference of this photoconductor drum 121, a transfer unit 123, a cleaning unit 124, and an ionizer unit.

The fixing unit 130 fixes an image transferred by the transfer unit 123 to a recording paper. The double-sided conveying unit 140 is provided at a downstream side in a recording paper conveying direction of the fixing unit 130 and includes a first switching nail 141 that switches the recording paper conveying direction to a paper post-processing device 500 side or a double-sided conveying unit 140 side, a reverse conveying path 142 guided by the first switching nail 141, an image-forming-side conveying path 143 that conveys a recording paper reversed by the reverse conveying path 142 again to a transfer unit 123 side, and a post-processing-side conveying path 144 that conveys a reversed recording paper to a paper post-processing device 500 side, and a second switching nail 145 is disposed at a branch point between the image-forming-side conveying path 143 and post-processing-side conveying path 144.

The paper feeding unit 150 is composed of four paper feeding tiers, from which respectively a recording paper stored in a paper feeding tier selected by a pickup roller and a paper feeding roller is drawn out and is guided to the vertical conveying unit 160. The vertical conveying unit 160 conveys a recording paper sent from each paper feeding tier to a resist roller 161 immediately before an upstream side in a paper conveying direction of the transfer unit 123, and the resist roller 161 sends a recording paper into the transfer unit 123 in timing with the front end of a manifest image on the photoconductor drum 121. The manual paper feeding unit 170 is provided with a manual paper feeding tray 171 that can be freely opened and closed, and the manual paper feeding tray 171 is opened if necessary so as to feed a recording paper by a manual feeding. In this case as well, the resist roller 161 weighs conveying timing of the recording paper for conveyance.

The large-capacity paper feeder 400 feeds identically-sized recording paper while stacking the same in bulk, and this is constructed so that a bottom plate 402 rises with consumption of the recording paper to make it possible to pick up a paper from a pickup roller 401. Recording paper fed by the pickup roller 401 is conveyed to a nip of the resist roller 161 from the vertical conveying unit 160.

The paper post-processing device 500 carries out predetermined processings such as punching, alignment, stapling, and sorting, and this is, for the functions, provided with a punch 501, a staple tray (alignment) 502, a stapler 503, and a shift tray 504 in this embodiment. Namely, recording paper carried into the paper post-processing device 500 from the image forming apparatus 100 is, when punching is carried out, individually punched by the punch 501, and is then ejected, if there is no particular processing to be done, into a proof tray 505, and when sorting, stacking, and sorting are carried out, into the shift tray 504. Sorting is, in this embodiment, carried out by the shit tray 504 reciprocating by a predetermined amount in a direction orthogonal to the paper conveying direction. In addition to this, sorting can also be carried out by shifting, in a paper conveying path, paper in a direction orthogonal to the paper conveying direction.

In a case of alignment, punched or non-punched recording paper is guided to a lower conveying path 506, is aligned in the staple tray 504 in a direction orthogonal to the paper conveying direction by a rear-end face, and is aligned in a direction parallel to the paper conveying direction by a jogger fence. Here, when stapling is carried out, an aligned sheaf of paper is stapled at a predetermined position such as, for example, a corner or two central points by the stapler 503, and is ejected into the shift tray 504 by a discharge belt. In this embodiment, a prestack conveying path 507 is provided in the lower conveying path 506 so that a plurality of sheets of paper can be stacked at conveyance so as to avoid an interruption of an image forming operation at the image forming apparatus 100 side during a post-processing.

For the image reading device 200, an image reading device wherein a lighting system of the conventional image reading device explained in FIG. 15 has been replaced with the lighting system explained in the first embodiment or the second embodiment described above is used. In this image reading device 200, a document guided onto a contact glass 210 by the ADF 300 and stopped is optically scanned, and a read image imaged by an imaging lens 7 through first to third mirrors 2, 4, and 5 is read by a photoelectric transducer such as a CCD 8 (or CMOS). The read image data is, after a predetermined image processing is executed therefor by an unillustrated image processing circuit, temporarily stored in a memory. Then, the image data is read out of the memory by the image writing unit 110 at image formation, and after a modulation according to the image data, an optical writing is carried out.

The ADF 300 has a double-sided reading function, and is attached to a contact glass 210 installing surface of the image reading device 200 so as to be freely opened and closed.

According to the present invention, by eliminating a light component in an infrared region where a photoelectric transducer has sensitivity at a light source side, a light in the region is cut from a reflected light component from a document surface, therefore, it becomes possible to match sensitivity of a photoelectric transducer to human vision characteristics, and consequently, an image reading can be carried out at reflection characteristics equivalent to human vision characteristics.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading device that reads image information by irradiating an illuminating light onto a document by an illumination unit and converting a reflected light from a surface of the document to an electric signal by a photoelectric transducer, wherein
the illumination unit includes a plurality of light emitting diodes (LED) and an infrared-cut unit that cuts a light having a wavelength in an infrared region from the illuminating light emitted by the LEDs.

2. The image reading device according to claim 1, wherein
the infrared-cut unit is provided adjacent to light emergent planes of the LEDs.

3. The image reading device according to claim 2, wherein
the infrared-cut unit includes an infrared-cut filter.

4. The image reading device according to claim 2, wherein
the infrared-cut unit is an infrared-cut filter layer provided on light emergent planes of the LEDs.

5. The image reading device according to claim 1, wherein
the infrared-cut unit is made of infrared-cut glass.

6. The image reading device according to claim 1, wherein
the infrared-cut unit is made of an infrared-cut resin.

7. The image reading device according to claim 1, wherein
the illuminating light has a continuous spectrum in a visible light region.

8. An image reading device that reads image information by irradiating an illuminating light onto a document by an illumination unit and converting a reflected light from the document surface to an electric signal by a photoelectric transducer, wherein
the illumination unit includes a plurality of light emitting diodes (LEDs), a light guide member that guides an illuminating light emitted by the LEDs toward a surfaced of the document, and an infrared-cut unit that cuts a light having a wavelength in an infrared region from the illuminating light emitted by the light guide member.

9. The image reading device according to claim 8, wherein
the infrared-cut unit is an infrared-cut filter arranged on a light emergent plane of the light guide member.

10. The image reading device according to claim 8, wherein
the infrared-cut unit is an infrared-cut filter layer coated on a light emergent plane of the light guide member.

11. The image reading device according to claim 8, wherein
the infrared-cut unit is an infrared-cut filter arranged on a light incident plane of the light guide member.

12. The image reading device according to claim 8, wherein
the infrared-cut unit is an infrared-cut filter layer coated on a light incident plane of the light guide member.

13. The image reading device according to claim 8, wherein
the infrared-cut unit is a light guide member provided by molding a material having infrared-cut characteristics.

14. The image reading device according to claim 8, wherein
the infrared-cut unit is made of infrared-cut glass.

15. The image reading device according to claim 8, wherein
the infrared-cut unit is made of an infrared-cut resin.

16. The image reading device according to claim 8, wherein
the illuminating light has a continuous spectrum in a visible light region.

17. An image reading device that reads image information by irradiating an illuminating light onto a document by an illumination unit and converting a reflected light from a surface of the document to an electric signal by a photoelectric transducer, wherein
the illumination unit includes a plurality of light emitting diodes (LEDs) that emit only a light having a wavelength shorter than a wavelength in an infrared region.

18. The image reading device according to claim 17, wherein
the LEDs are composed of white LEDs each comprising a yellow fluorescent material and a blue luminous body whose light-emitting plane is covered by this yellow fluorescent material and from which a light is emitted through the yellow fluorescent material.

19. The image reading device according to claim 18, wherein
the yellow florescent material is a YAG-based fluorescent material containing yttrium, aluminum and garnet.

20. The image reading device according to claim 17, wherein
the LEDs are composed of white LEDs each comprising a blue light-emitting section by a ZnSe base and a ZnSe single crystal substrate.

21. The image reading device according to claim 17, wherein
the illuminating light has a continuous spectrum in a visible light region.

22. An image forming apparatus comprising an image reading device that reads image information by irradiating an illuminating light onto a document by an illumination unit and converting a reflected light from a surface of the document to an electric signal by a photoelectric transducer, wherein
the illumination unit includes a plurality of light emitting diodes (LED) and an infrared-cut unit that cuts a light having a wavelength in an infrared region from the illuminating light emitted by the LEDs.

23. An image forming apparatus comprising an image reading device that reads image information by irradiating an illuminating light onto a document by an illumination unit and converting a reflected light from a surface of the document to an electric signal by a photoelectric transducer, wherein
the illumination unit includes LEDs, a light guide member that guides an illuminating light emitted by the LEDs toward the document surface, and an infrared-cut unit that cuts a light having a wavelength in an infrared region from the illuminating light emitted by the light guide member.

24. An image forming apparatus comprising an image reading device that reads image information by irradiating an illuminating light onto a document by an illumination unit and converting a reflected light from a surface of the document to an electric signal by a photoelectric transducer, wherein
the illumination unit includes LEDs that emit only a light having a wavelength shorter than a wavelength in an infrared region.

25. An image reading method applied to read image information by irradiating an illuminating light onto a document and converting a reflected light from a document surface to an electric signal by a photoelectric transducer, the method comprising:
irradiating onto a surface of the document an illuminating light whose light component in an infrared region out of the visible light spectrum has been reduced to an intensity sufficiently low relative to a sensitivity of the photoelectric transducer, and
reading the reflected light from the surface of the document.

26. The image reading method according to claim 25, wherein
the light component in the infrared region is a light having a wavelength at least equal to or more than 650 nanometers.
